(19) United States
(12) Patent Application Publication
(10) Pub. No.: US 2013/0203380 A1
(43) Pub. Date: Aug. 8, 2013

(54) NETWORK DEVICE, CORE NETWORK, DIRECT MODE COMMUNICATION SYSTEM AND LAWFUL INTERCEPTION METHOD THEREOF

(71) Applicant: INSTITUTE FOR INFORMATION INDUSTRY, Taipei (TW)

(72) Inventors: Yi-Ting LIN, New Taipei City (TW); Yi-Hsueh TSAI, New Taipei City (TW); Kanchei Loa, Taipei City (TW)

(73) Assignee: INSTITUTE FOR INFORMATION INDUSTRY, Taipei (TW)

(21) Appl. No.: 13/757,768

(22) Filed: Feb. 2, 2013

Related U.S. Application Data
(60) Provisional application No. 61/595,133, filed on Feb. 5, 2012.
(60) Provisional application No. 61/642,466, filed on May 4, 2012.
(60) Provisional application No. 61/672,785, filed on Jul. 18, 2012.

(51) Int. Cl. H04W 12/02

(52) U.S. Cl. CPC H04W 12/02
USPC 455/410

(57) ABSTRACT

A network device, a core network, a direct mode communication system and a lawful interception method thereof are provided. The direct mode communication system includes the network device and the core network, and connects to a first mobile station and a second mobile station respectively. The network device registers to the core network for intercepting a communication between the first mobile station and the second mobile station and retrieves a communication data by intercepting the communication. The core network receives the communication data from the network device and stores the communication data.

### PRIORITY

This application claims the benefit of U.S. Provisional Application Ser. No. 61/595,133 filed on Feb. 5, 2012, U.S. Provisional Application Ser. No. 61/642,466 filed on May 4, 2012, and U.S. Provisional Application Ser. No. 61/672,785 filed on Jul. 18, 2012.

### FIELD

The present invention relates to a network device, a core network, a direct mode communication system and a lawful interception method thereof. More particularly, the network device, the core network, the direct mode communication system and the lawful interception method thereof are arranged for intercepting the communications between mobile stations used in direct mode communication.

### BACKGROUND

For security reasons, legal communication intercepting techniques are necessary. In the general communication systems, mobile stations connect to backend network directly, and have to exchange data (voice data, text data etc.) with each other via the backend network. In other words, the data exchanged between the mobile stations must be processed by the backend work. Therefore, when an inception is authorized by the court, an authorized user needs to ask the operator of the backend network for obtaining the data which is exchanged between the mobile stations and stored in the backend network.

However, in the developing 3GPP direct mode communication network, although mobile stations still connect to backend network, they exchange data with each other directly. In other words, in 3GPP direct mode communication network, the data exchange between the mobile stations will not be processed by the backend network. Accordingly, an authorized user can not obtain the data exchanged between the mobile stations from the backend network since the data may not be stored in the backend network.

Accordingly, in order to implement lawful interception for 3GPP direct mode communication network, corresponding protocols and hardware devices differed from the general communication system are needed.

### SUMMARY

To solve the aforesaid problem, the present invention provides a network device, a core network, a direct mode communication system and a lawful interception method thereof, which can be used for intercepting the communications between mobile stations adapted to direct mode communication.

To achieve the aforesaid objective, certain embodiments of the present invention provide a lawful interception method for a direct mode communication system. The direct mode communication system comprises a network device and a core network. A first mobile station and a second mobile station connect to the core network respectively. The lawful interception method comprises the steps of: (a) enabling the network device to register to the core network for intercepting a communication between the first mobile station and the second mobile station; (b) enabling the network device to retrieve a communication data by intercepting the communication; (c) enabling the core network to receive the communication data from the network device; and (d) enabling the core network to store the communication data.

To achieve the aforesaid objective, certain embodiments of the present invention further provides a direct mode communication system which comprises a network device and a core network connecting to a first mobile station and a second mobile station respectively. The network device registers to the core network for intercepting a communication between the first mobile station and the second mobile station, and retrieves a communication data by intercepting the communication. The core network receives the communication data from the network device and stores the communication data.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view of a direct mode communication system of a first embodiment of the present invention;

FIG. 1B is a schematic view of a network device of the first embodiment of the present invention;

FIG. 1C is a schematic view of a core network of the first embodiment of the present invention;

FIG. 2 is a schematic view of a direct mode communication system of a second embodiment of the present invention;

FIG. 3A is a schematic view of a direct mode communication system of a third embodiment of the present invention;

FIG. 3B is a schematic view of a core network of the third embodiment of the present invention;

FIG. 4 is a schematic view of a direct mode communication system of a fourth embodiment of the present invention;

FIG. 5 is a schematic view of a direct mode communication system of a fifth embodiment of the present invention;

FIG. 6 is a flowchart diagram of a lawful interception method of a sixth embodiment of the present invention;

FIG. 7 is a flowchart diagram of a lawful interception method of a seventh embodiment of the present invention;

FIG. 8 is a flowchart diagram of a lawful interception method of an eighth embodiment of the present invention;

FIG. 9 is a flowchart diagram of a lawful interception method of a ninth embodiment of the present invention; and

FIG. 10 is a flowchart diagram of a lawful interception method of a tenth embodiment of the present invention.

### DETAILED DESCRIPTION

In the following description, the present invention will be explained with reference to example embodiments thereof. However, these example embodiments are not intended to limit the present invention to any specific example, embodiment, environment, applications or particular implementations described in these embodiments. Therefore, description of these embodiments is only for purpose of illustration rather than to limit the present invention. It should be appreciated that, in the following embodiments and the attached drawings, elements unrelated to the present invention are omitted from depiction.

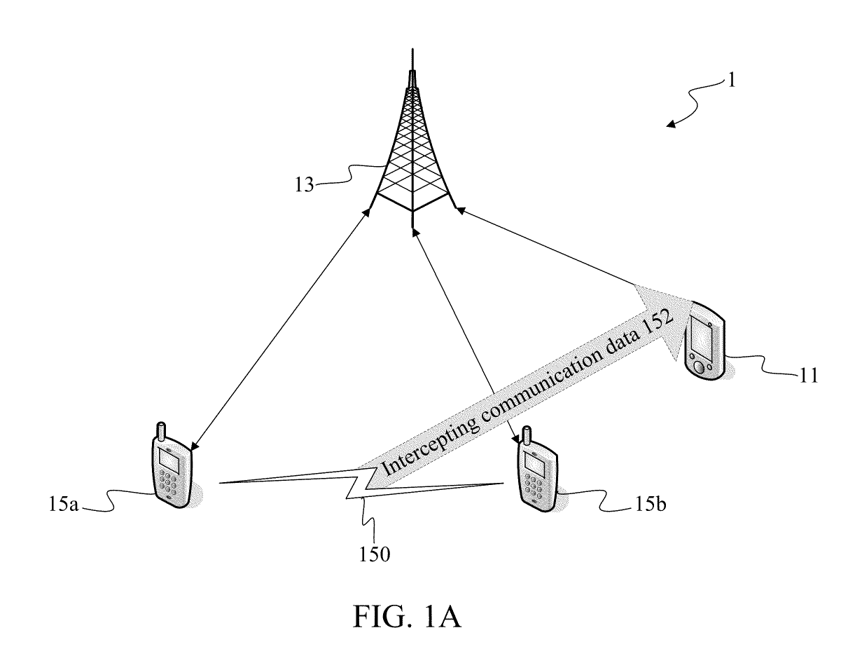

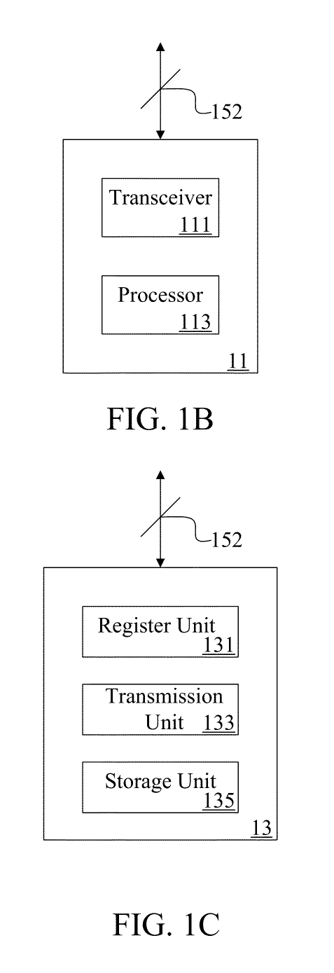

Refer to FIG. 1A to FIG. 1C. FIG. 1A is a schematic view of a direct mode communication system 1 of a first embodiment of the present invention. The direct mode communication 1 comprises a network device 11 and a core network 13 which connects to a first mobile station 15a and a second mobile station 15b. FIG. 1B is a schematic view of the network device 11 of the first embodiment of the present invention. The network device 11 comprises a transceiver 111 and a processor 113. FIG. 1C is a schematic view of the core network 13 of the first embodiment of the present invention. The core network 13 comprises a register unit 131, a transmission unit 133 and a storage unit 135.

It shall be firstly appreciated that, the core network of the present invention may be a backend operating network composed of different hardware servers with different functions such as a server with register function, a server with transmitting function, a server with storing function or a server with processing function. However, this is not intended to limit the implementations of the present invention. Interactions between the network components will be further elucidated herein below.

Firstly, when monitoring the communications between the first mobile station 15a and the second mobile station 15b is needed for some security reasons, a legal user (for example, law enforcement officer) can request the court for authorizing lawful interception. Next, after being authorized, the user can initiate the lawful interception with the following steps by the network device 11.

Specifically, in order to inform the core network 13 of taking part in the direct mode communication, the processor 113 of the network device 11 registers to the core network 13 via the transceiver 111 for intercepting a communication 150 between the first mobile station 15a and the second mobile station 15b. In other words, the network device 11 notifies the core network 13 of intercepting. Accordingly, the register unit 131 is informed and registers the network device 11 for intercepting the communication 150.

After the network device 11 registering for taking part in the direct mode communication system 1, the transceiver 113 of the network device 11 starts to retrieve a communication data 152 by intercepting the communication 150. Therefore, the network device 11 can obtain and monitor the information exchanged between the first mobile station 15a and the second mobile station 15b accordingly.

Then, the processor 113 of the network device 11 stores the communication data 152 in the core network 13 (or stores in network device 11 itself temporally if network device 11 has enough storage space) via the transceiver 111 for later use. In other words, the transmission unit 133 of the core network 13 receives the communication data 152 from the network device 11 and the storage unit 135 of the core network 13 stores the communication data 152 for later use. Accordingly, based on the first embodiment of the present invention, lawful interceptions in direct mode communication system 1 can be implemented.

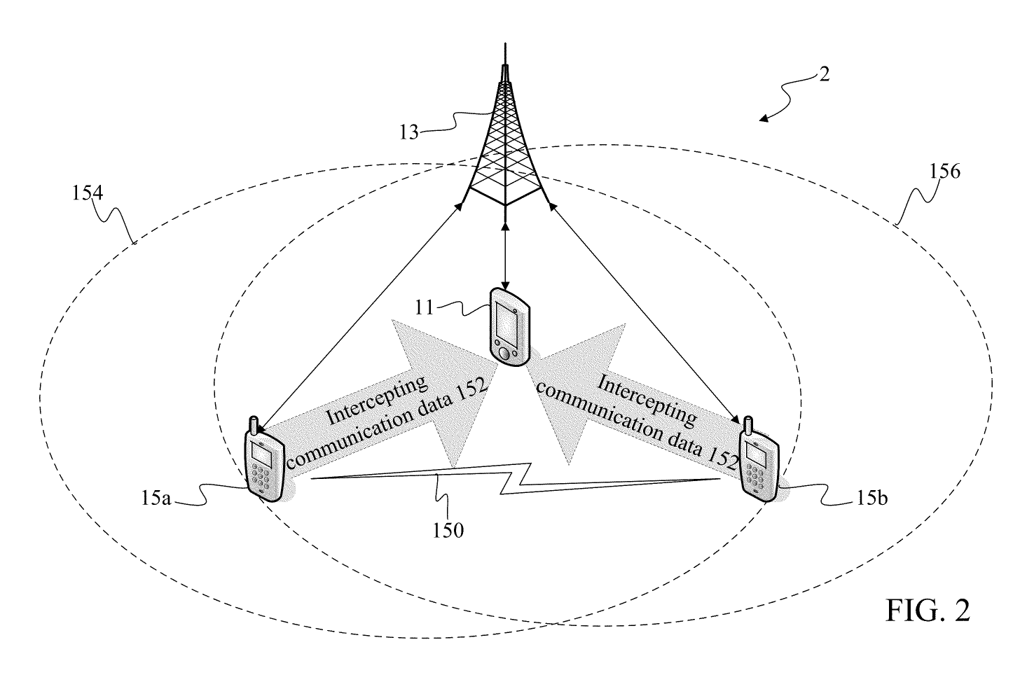

Referring to FIG. 2, there is shown a schematic view illustrating a direct mode communication system 2 of a second embodiment of the present invention. It shall be particularly appreciated that, the second embodiment has the same system architecture and the same network connection environment as the first embodiments, so the components bearing the same reference numerals also have the same functions and will not be further described herein.

Particularly, the network device 11 is within a first communicating coverage 154 of the first mobile station 15a and a second communicating coverage 156 of the second mobile station 15b at the same time. Accordingly, the transceiver 111 of the network device 11 connects to the first mobile station 15a and the second mobile station 15b at the same time, and receives the communication data 152 by intercepting the communication 150 directly from both of the first mobile station 15a and the second mobile station 15b.

However, it should be noted that, if the network device 11 is not within the first communicating coverage 154 of the first mobile station 15a or the second communicating coverage 156 of the second mobile station 15b, communication powers of the first mobile station 15a and the second mobile station 15b should be adjusted.

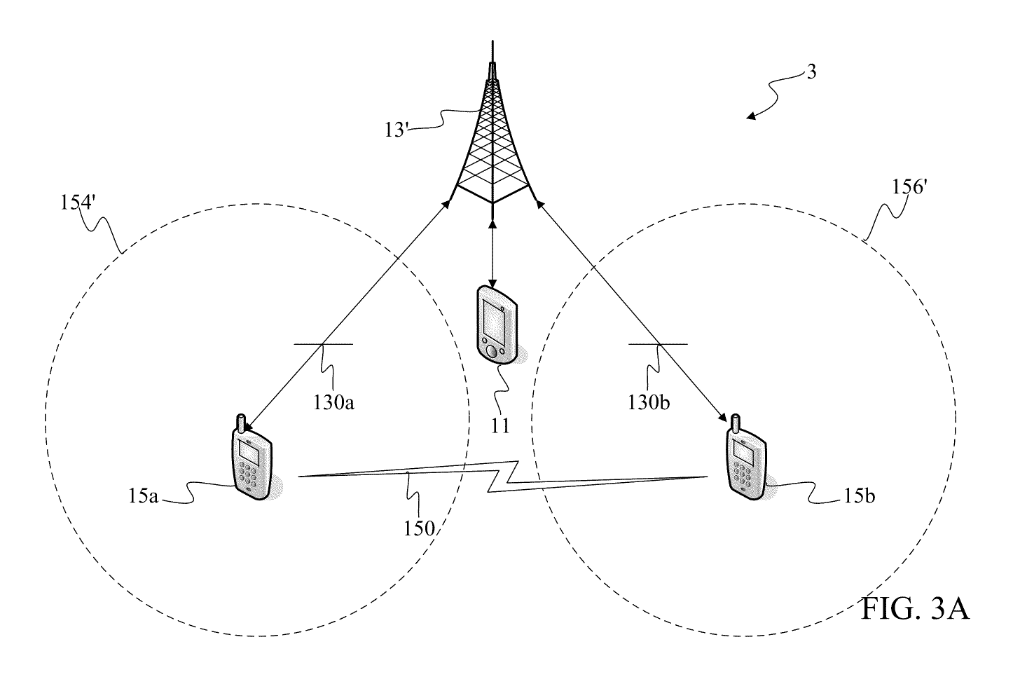

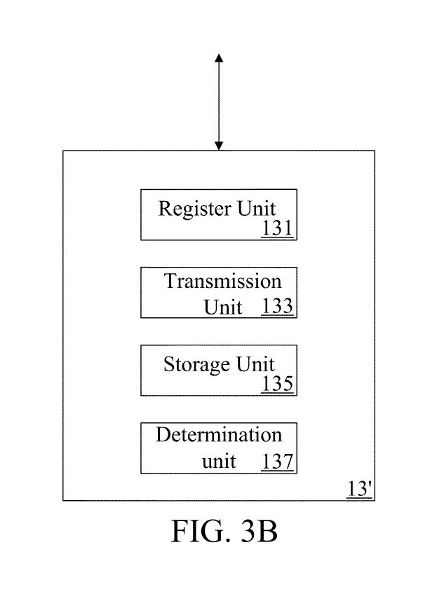

Please refer to FIG. 3A and FIG. 3B. FIG. 3A is a schematic view of a direct mode communication system 3 of a third embodiment of the present invention, and FIG. 3B is a schematic view of a core network 13′ of the third embodiment of the present invention. It shall be particularly noted that, the hardware structure and the network connection environment of the third embodiment are similar to those of the second embodiment, so components bearing the same reference numerals have the same functions and will not be further described herein. The third embodiment differs from the second embodiment in that, the core network 13′ further comprises a determination unit 137.

Specifically, the determination unit 137 of the core network 13′ is used for determining whether the network device 11 is within communicating coverage 154′, 156′ of the first mobile station 15a and the second mobile station 15b. Then, when the determination unit 137 of the core network 13′ determines that the network device 11 is not within the communicating coverage 154′ of the first mobile station 15a or the communicating coverage 156′ of the second mobile station 15b, the transmission unit 133 further transmits power adjustment signals 130a and 130b to the first mobile station 15a and the second mobile station 15b respectively for secretly adjusting communication powers of the first mobile station 15a and the second mobile station 15b.

Accordingly, the network device 11 is capable of connecting to the first mobile station 15a and the second mobile station 15b at the same time, and the transceiver 111 is capable of receiving communication data by intercepting a communication between the first mobile station 15a and the second mobile station 15b directly from the first mobile station 15a and the second mobile station 15b.

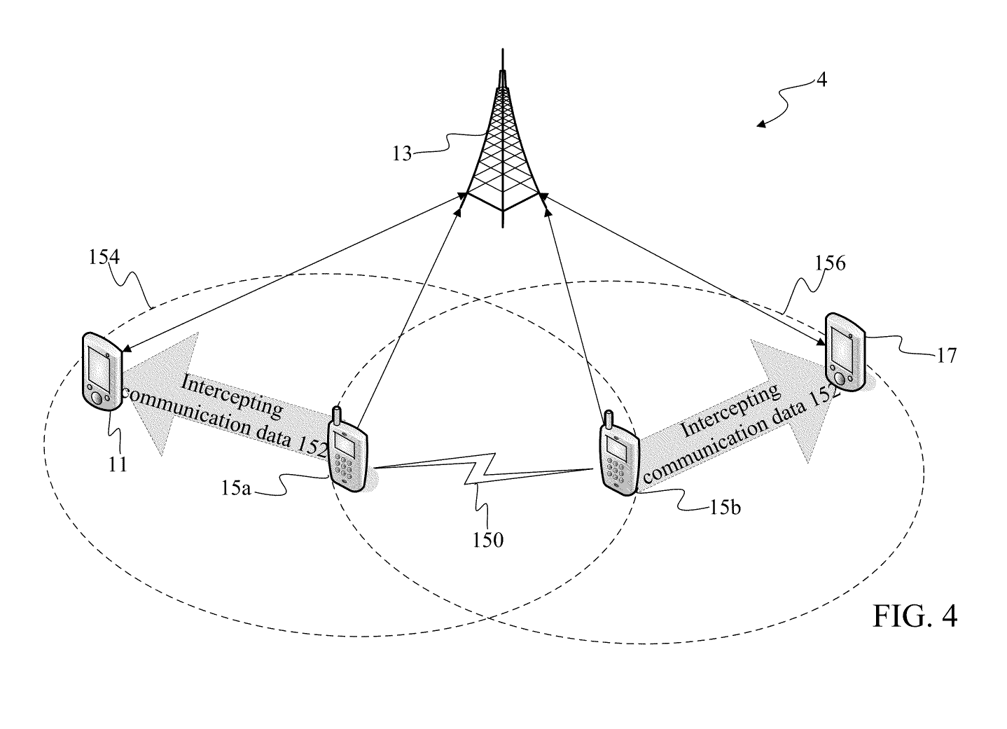

Referring to FIG. 4, there is shown a schematic view illustrating a direct mode communication system 4 of a fourth embodiment of the present invention. It shall be particularly appreciated that, the fourth embodiment has the same system architecture and the same network connection environment as the aforesaid embodiments, so the components bearing the same reference numerals also have the same functions and will not be further described herein. However, the fourth embodiment differs from the aforesaid embodiments in that: the network device 11 is only within the communicating coverage 154 of the first mobile station 15a, so a network device 17 (comprising the same components as the network device 11) is further introduced into the direct mode communication system 4 for intercepting the data transmitted from the second mobile station 15b.

Particularly, when the network device 11 is only within the communicating coverage 154 of the first mobile station 15a, the transceiver 111 of the network device 11 can only connects the first mobile station 15a and intercepts the communication data 152 of the first mobile station 15a. Accordingly, the network device 17 is introduced for connecting the second mobile station 15b and intercepts the communication data 152 of the second mobile station 15b. Therefore, the intercepting data of the communication 150 are more complete.

Furthermore, in other embodiment, the first mobile station 15a can be one member of a mobile station group, and the network device 11 can obtain partial communicating information of the mobile station group directly from the first mobile station 15a since the network device 11 only connects to the first mobile station 15a.

It should also be noted that, in the fourth embodiment, if the network device 11 is not within the first communicating coverage 154 of the first mobile station 15a, or network device 17 is not within the second communicating coverage 156 of the second mobile station 15b, communication powers of the first mobile station 15a and the second mobile station 15b should be adjusted via extra determination units as described in the third embodiment. Therefore, the detail of power adjustment will not be further described herein.

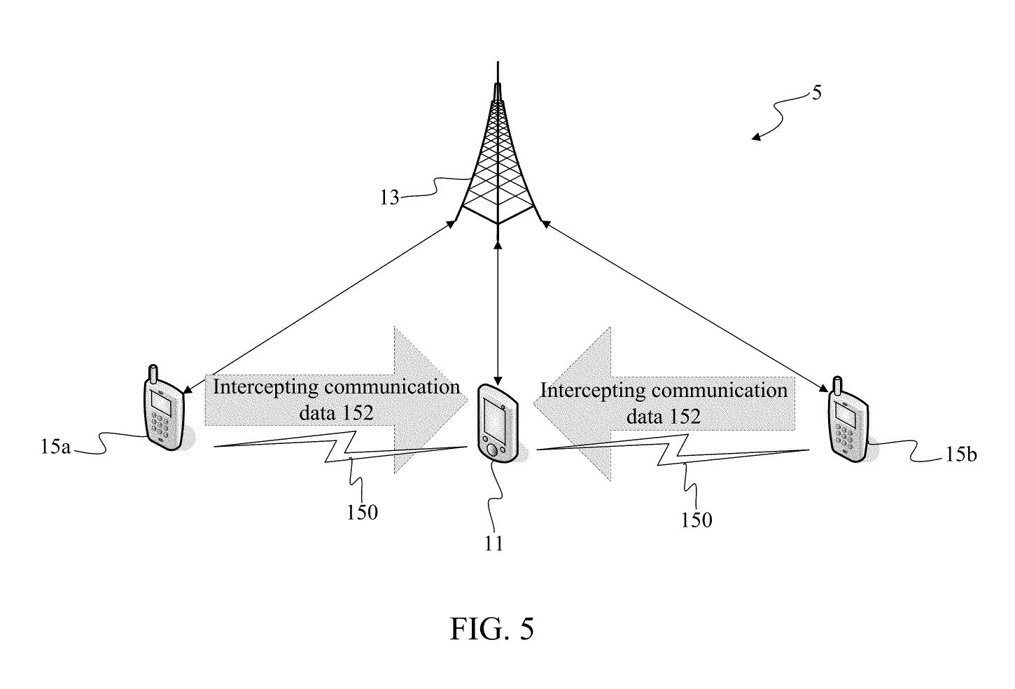

Referring to FIG. 5, there is shown a schematic view illustrating a direct mode communication system 5 of a fifth embodiment of the present invention. It shall be particularly appreciated that, the fifth embodiment has the same system architecture and the same network connection environment as the first embodiments, so the components bearing the same reference numerals also have the same functions and will not be further described herein.

Particularly, in the fifth embodiment, the network device 11 is a relay station, and the first mobile station 15a communicates with the second mobile station 15b via the network device 11. Accordingly, the transceiver 111 of the network device 11 is capable of retrieving the communication data 152 by intercepting the communication 150 while relaying the communication data 152 between the first mobile station 15a and the second mobile station 15b.

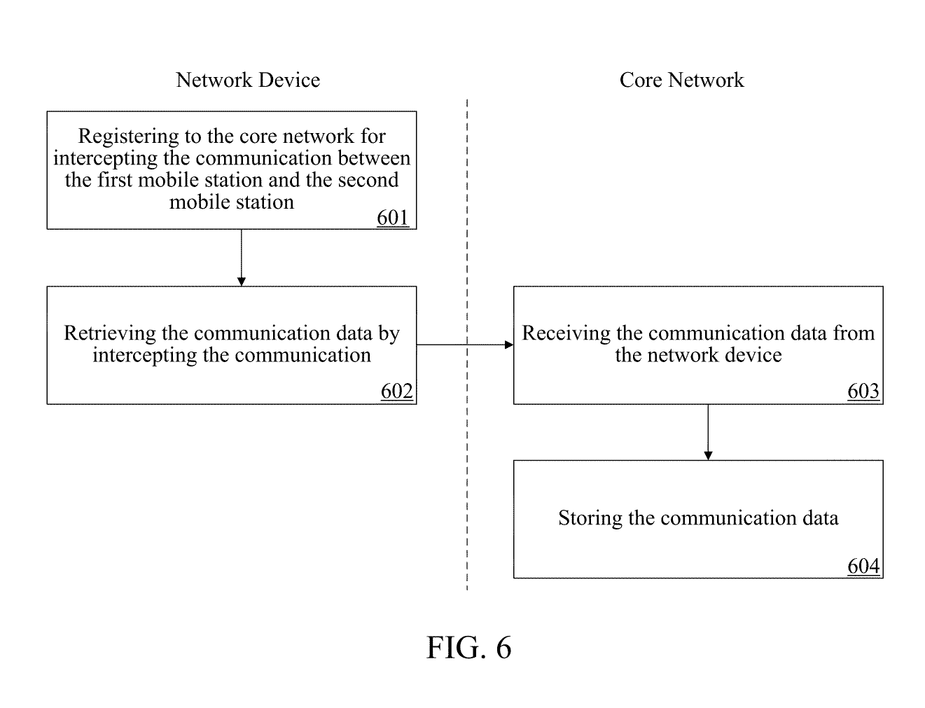

A sixth embodiment of the present invention is a lawful interception method. A flowchart diagram of which is shown in FIG. 6. The lawful interception method of the sixth embodiment is for use in a direct mode communication system (e.g., the direct mode communication system 1 of the first embodiment). The direct mode communication system further comprises a core network. A first mobile station and a second mobile station connect to the core network respectively. Steps of the sixth embodiment are detailed as follows.

Firstly, step 601 is executed to enable the network device to register to the core network for intercepting a communication between the first mobile station and the second mobile station. Then, step 602 is executed to enable the network device to retrieve a communication data by intercepting the communication. Next, the network device stores the communication data in the core network, so step 603 is executed to enable the core network to receive the communication data from the network device. Final, step 604 is executed to enable the core network to store the communication data.

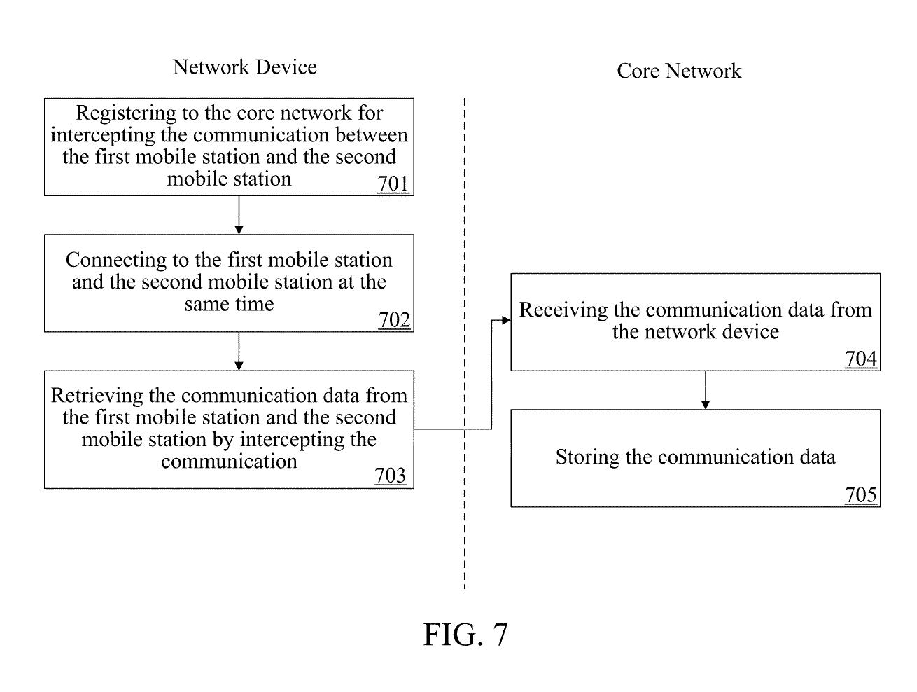

A seventh embodiment of the present invention is a lawful interception method. A flowchart diagram of which is shown in FIG. 7. The lawful interception method of the seventh embodiment is for use in a direct mode communication system (e.g., the direct mode communication system 2 of the second embodiment). The direct mode communication system further comprises a core network. A first mobile station and a second mobile station connect to the core network respectively. Steps of the seventh embodiment are detailed as follows.

Firstly, step 701 is executed to enable the network device to register to the core network for intercepting a communication between the first mobile station and the second mobile station. Then, step 702 is executed to enable the network device to connect to the first mobile station and the second mobile station at the same time. Step 703 is executed to enable the network device to retrieve the communication data from the first mobile station and the second mobile station by intercepting the communication. Next, the network device stores the communication data in the core network, so step 704 is executed to enable the core network to receive the communication data from the network device. Final, step 705 is executed to enable the core network to store the communication data.

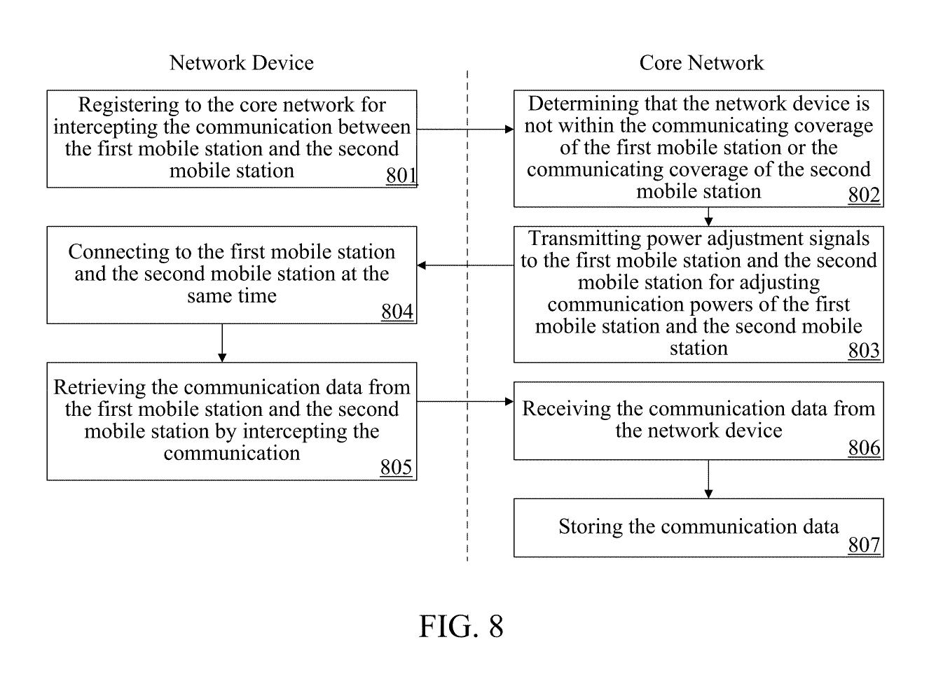

An eighth embodiment of the present invention is a lawful interception method. A flowchart diagram of which is shown in FIG. 8. The lawful interception method of the seventh embodiment is for use in a direct mode communication system (e.g., the direct mode communication system 3 of the second embodiment). The direct mode communication system further comprises a core network. A first mobile station and a second mobile station connect to the core network respectively. Steps of the eighth embodiment are detailed as follows.

Firstly, step 801 is executed to enable the network device to register to the core network for intercepting a communication between the first mobile station and the second mobile station. Step 802 is executed to enable the core network to determine that the network device is not within a communicating coverage of the first mobile station or a communicating coverage of the second mobile station. Next, step 803 is executed to enable the core network to transmit power adjustment signals to the first mobile station and the second mobile station for adjusting communication powers of the first mobile station and the second mobile station.

Then, step 804 is executed to enable the network device to connect to the first mobile station and the second mobile station at the same time. Step 805 is executed to enable the network device to retrieve the communication data from the first mobile station and the second mobile station by intercepting the communication. Next, the network device stores the communication data in the core network, so step 806 is executed to enable the core network to receive the communication data from the network device. Final, step 807 is executed to enable the core network to store the communication data.

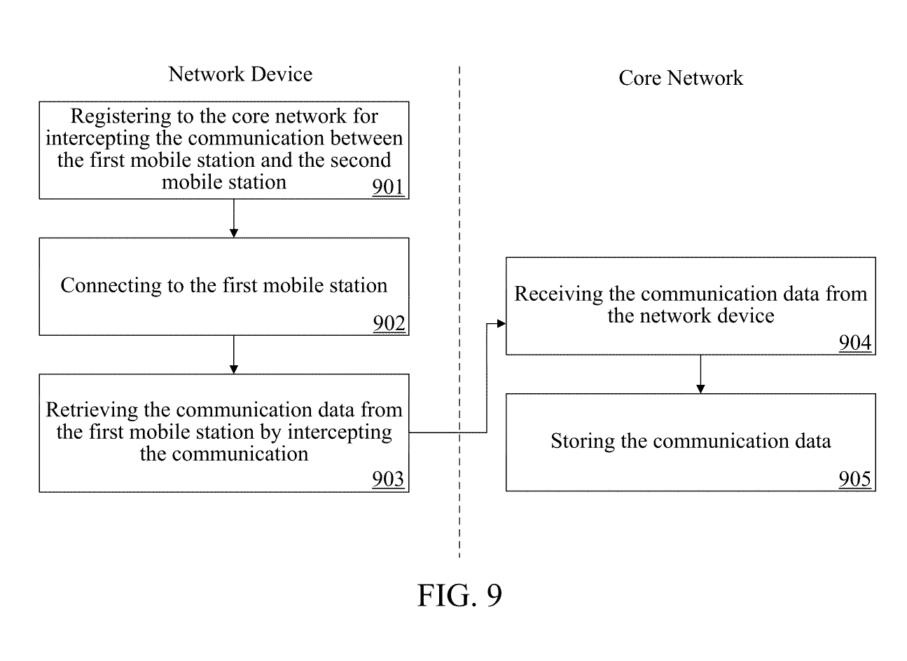

A ninth embodiment of the present invention is a lawful interception method. A flowchart diagram of which is shown in FIG. 9. The lawful interception method of the ninth embodiment is for use in a direct mode communication system (e.g., the direct mode communication system 4 of the fourth embodiment). The direct mode communication system further comprises a core network. A first mobile station and a second mobile station connect to the core network respectively. Steps of the ninth embodiment are detailed as follows.

Firstly, step 901 is executed to enable the network device to register to the core network for intercepting a communication between the first mobile station and the second mobile station. Then, step 902 is executed to enable the network device to connect to the first mobile station only. Step 903 is executed to enable the network device to retrieve the communication data from the first mobile station by intercepting the communication. Next, the network device stores the communication data in the core network, so step 904 is executed to enable the core network to receive the communication data from the network device. Final, step 905 is executed to enable the core network to store the communication data.

Similarly, it should be noted that in the ninth embodiment, if the network device is not within the first communicating coverage of the first mobile station, communication power of the first mobile station should be adjusted as described in the eighth embodiment. Therefore, the detail of power adjustment will not be further described herein.

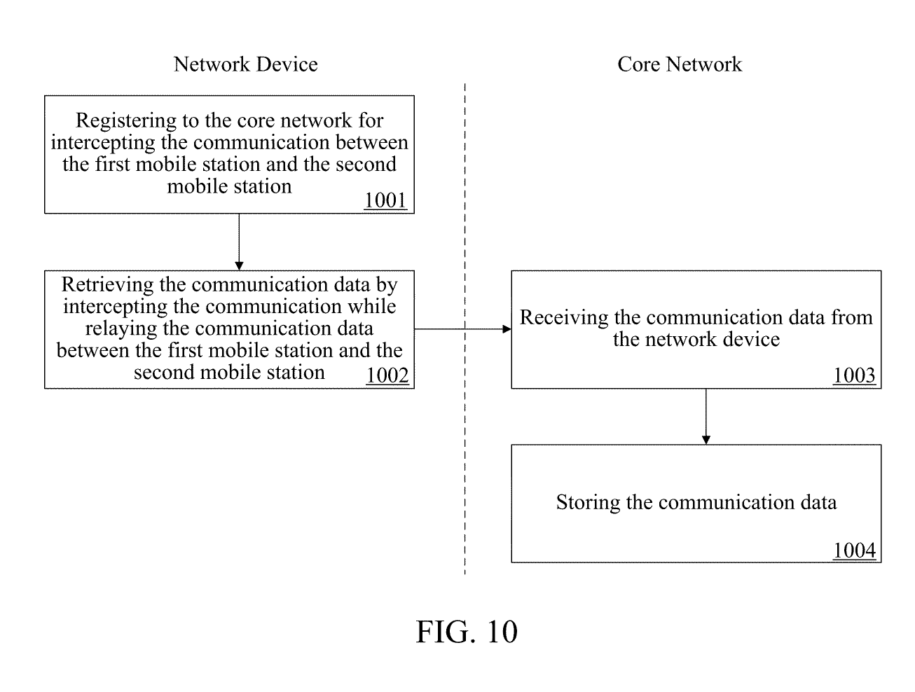

A tenth embodiment of the present invention is a lawful interception method. A flowchart diagram of which is shown in FIG. 10. The lawful interception method of the tenth embodiment is for use in a direct mode communication system (e.g., the direct mode communication system 5 of the first embodiment). The direct mode communication system further comprises a core network. A first mobile station and a second mobile station connect to the core network respectively. The first mobile station communicates with the second station via the network device. Steps of the tenth embodiment are detailed as follows.

Firstly, step 1001 is executed to enable the network device to register to the core network for intercepting a communication between the first mobile station and the second mobile station. Then, step 1002 is executed to enable the network device to retrieve a communication data by intercepting the communication while relaying the communication data between the first mobile station and the second mobile station. Next, the network device stores the communication data in the core network, so step 1003 is executed to enable the core network to receive the communication data from the network device. Final, step 1004 is executed to enable the core network to store the communication data.

According to the above descriptions, the network device and the lawful interception method of the present invention can be introduced in the direct mode communication for intercepting the communications between mobile stations of direct mode communication.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A lawful interception method for a network device, the network device being used in a direct mode communication system, the direct mode communication system comprising a core network, a first mobile station and a second mobile station connecting to the core network respectively, the lawful interception method comprising the steps of:
(a) enabling the network device to register to the core network for intercepting a communication between the first mobile station and the second mobile station;
(b) enabling the network device to retrieve a communication data by intercepting the communication;
(c) enabling the network device to store the communication data in the core network.

2. The lawful interception method as claimed in claim 1, wherein step (b) further comprises the following steps:
(b1) enabling the network device to connect to the first mobile station;
(b2) enabling the network device to retrieve the communication data from the first mobile station by intercepting the communication.

3. The lawful interception method as claimed in claim 2, wherein step (b1) further comprises the following step:
(b11) enabling the network device to connect to the first mobile station after the core network determines that the network device is not within a communicating coverage of the first mobile station, and then transmits a power adjustment signal to the first mobile station for adjusting communication power of the first mobile station.

4. The lawful interception method as claimed in claim 1, wherein step (b) further comprises the following steps:
(b1) enabling the network device to connect to the first mobile station and the second mobile station at the same time;
(b2) enabling the network device to retrieve the communication data from the first mobile station and the second mobile station by intercepting the communication.

5. The lawful interception method as claimed in claim 4, wherein step (b1) further comprises the following step:
(b11) enabling the network device to connect to the first mobile station and the second mobile station at the same time after the core network determines that the network device is not within a communicating coverage of the first mobile station or a communicating coverage of the second mobile station, and then transmits power adjustment signals to the first mobile station and the second mobile station for adjusting communication powers of the first mobile station and the second mobile station.

6. The lawful interception method as claimed in claim 1, wherein the first mobile station communicates with the second mobile station via the network device, and step (b) further comprises the following step:
(b1) enabling the network device to retrieve the communication data by intercepting the communication while relaying the communication data between the first mobile station and the second mobile station.

7. A lawful interception method for a core network, the core network being used in a direct mode communication system, the direct mode communication system comprising a network device, a first mobile station and a second mobile station connecting to the core network respectively, the lawful interception method comprising the steps of:
(a) enabling the core network to register the network device for intercepting a communication between the first mobile station and the second mobile station;
(b) enabling the core network to receive a communication data from the network device after the network device retrieves the communication data by intercepting the communication;
(c) enabling the core network to store the communication data.

8. The lawful interception method as claimed in claim 7, further comprising the following step after step (a):
(a1) enabling the core network to determine that the network device is not within a communicating coverage of the first mobile station;
(a2) enabling the core network to transmit a power adjustment signal to the first mobile station for adjusting communication power of the first mobile station after step (a1) so that the network device is capable of connecting to the first mobile station.

9. The lawful interception method as claimed in claim 7, further comprising the following step after step (a):
(a1) enabling the core network to determine that the network device is not within a communicating coverage of the first mobile station or a communicating coverage of the second mobile station;
(a2) enabling the core network to transmit power adjustment signals to the first mobile station and the second mobile station for adjusting communication powers of the first mobile station and the second mobile station after step (a1) so that the network device is capable of connecting to the first mobile station and the second mobile station at the same time.

10. A lawful interception method for a direct mode communication system, the direct mode communication system comprising a network device and a core network, a first mobile station and a second mobile station connecting to the core network respectively, the lawful interception method comprising the steps of:
(a) enabling the network device to register to the core network for intercepting a communication between the first mobile station and the second mobile station;
(b) enabling the network device to retrieve a communication data by intercepting the communication;
(c) enabling the core network to receive the communication data from the network device;
(d) enabling the core network to store the communication data.

11. A network device for use in a direct mode communication system, the direct mode communication system comprising a core network, a first mobile station and a second mobile station connecting to the core network respectively, the network device comprises:
a transceiver; and
a processor;
wherein the processor is configured to register to the core network via the transceiver for intercepting a communication between the first mobile station and the second mobile station, the transceiver is configured to retrieve a communication data by intercepting the communication, and the processor is further configured store the communication data in the core network via the transceiver.

12. The network device as claimed in claim 11, wherein the transceiver is further configured to connect to the first mobile station, and retrieve the communication from the first mobile station by intercepting the communication.

13. The network device as claimed in claim 12, wherein the transceiver is further configured to connect to the first mobile station after the core network determines that the network device is not within a communicating coverage of the first mobile station, and then transmits a power adjustment signal to the first mobile station for adjusting communication power of the first mobile station.

14. The network device as claimed in claim 11, wherein the transceiver is further configured to connect to the first mobile station and the second mobile station at the same time, and retrieve the communication data from the first mobile station and the second mobile station by intercepting the communication.

15. The network device as claimed in claim 14, wherein the transceiver is further configured to connect to the first mobile station and the second mobile station at the same time after the core network determines that the network device is not within a communicating coverage of the first mobile station or a communicating coverage of the second mobile station, and then transmits power adjustment signals to the first mobile station and the second mobile station for adjusting communication powers of the first mobile station and the second mobile station.

16. The network device as claimed in claim 11, wherein the first mobile station communicates with the second mobile station via the network device, and the transceiver is further configured to retrieve the communication data by intercepting the communication while relaying the communication data between the first mobile station and the second mobile station.

17. A core network for use in a direct mode communication system, the direct mode communication system comprising a network device, a first mobile station and a second mobile station connecting to the core network respectively, the core network comprising:
a register unit, being configured to register the network device for intercepting a communication between the first mobile station and the second mobile station;
a transmission unit, being configured to receive a communication data from the network device after the network device retrieves the communication data by intercepting the communication;
a storage unit, being configured to store the communication data.

18. The core network as claimed in claim 17, further comprising:
a determination unit, being configured to determine that the network device is not within a communicating coverage of the first mobile station;
wherein the transmission unit is further configured to transmit a power adjustment signal to the first mobile station for adjusting communication power of the first mobile station after the determination unit determines the network device is not within a communicating coverage of the first mobile station so that the network device is capable of connecting to the first mobile station.

19. The core network as claimed in claim 17, further comprising:
a determination unit, being configured to determine that the network device is not within a communicating coverage of the first mobile station or a communicating coverage of the second mobile station;
wherein the transmission unit is further configured to transmit power adjustment signals to the first mobile station and the second mobile station for adjusting communication powers of the first mobile station and the second mobile station after the determination unit determines that the network device is not within a communicating coverage of the first mobile station or a communicating coverage of the second mobile station so that the network device is capable of connecting to the first mobile station and the second mobile station at the same time.

20. A direct mode communication system, comprising:
a network device;
a core network, connecting to a first mobile station and a second mobile station respectively;
wherein the network device registers to the core network for intercepting a communication between the first mobile station and the second mobile station and retrieves a communication data by intercepting the communication, and the core network receives the communication data from the network device and stores the communication data.
